(19) United States
(12) Patent Application Publication
(10) Pub. No.: US 2022/0237966 A1
(43) Pub. Date: Jul. 28, 2022

(54) Automatic Wireless Door Opening System and Method of Using the Same

(71) Applicant: Bluetech Automation, LLC, Chicago, IL (US)

(72) Inventors: Steve Szymke, Chicago, IL (US); Joshua Gramlich, Peoria, IL (US)

(21) Appl. No.: 17/671,058

(22) Filed: Feb. 14, 2022

Related U.S. Application Data
(63) Continuation of application No. 15/312,438, filed on Nov. 18, 2016, now abandoned.
(60) Provisional application No. 62/001,150, filed on May 21, 2014.

(51) Int. Cl. G07C 9/00; H04W 4/80; G07C 9/20; H04M 1/72412

(52) U.S. Cl. CPC G07C 9/00309; H04W 4/80; G07C 9/20; E05F 15/77; G07C 2009/00769; G07C 2009/00928; H04M 1/72412

(57) ABSTRACT

The present invention relates to an automatic wireless Bluetooth®-enabled garage door opener, gate opener or other automatic door opening system and method. Specifically, the door opener system and method comprises a Bluetooth wireless receiver interconnected to a low voltage wired garage door opening system, and a control application on a smart device, such as a smart phone, tablet, or other like Bluetooth®-enabled wireless transmitter.

The present invention claims priority to U.S. patent application Ser. No. 15/312,438, filed Nov. 18, 2016, which is a 371 U.S. national stage application of PCT Pat. App. No. PCT/US2015/031881, filed May 21, 2015, which claims priority to U.S. Prov. Pat. App. No. 62/001,150, filed May 21, 2014, each of which is titled “Automatic Wireless Door Opening System and Method of Using the Same”, and each of which is incorporated herein by reference in its entirety.

### TECHNICAL FIELD

The present invention relates to an automatic wireless Bluetooth®-enabled garage door opener, gate opener or other automatic door opening system and method. Specifically, the door opener system and method comprises a Bluetooth wireless receiver interconnected to a low voltage wired or wireless garage door opening system, and a control application on a smart device, such as a smart phone, tablet, or other like Bluetooth®-enabled wireless transmitter.

### BACKGROUND

Wireless automatic garage door openers have been utilized for many years. Indeed, the first electric garage door opener can be traced to inventor C. G. Johnson in 1926, and included a motor that moved an arm back and forth along a track for lifting a garage door. A remote control was introduced to electric garage door openers several years after that, and allowed radio waves to be sent by a transmitter and received by a receiver, signaling to the electric motor to move one way to raise the garage door or the other way to close the garage door, depending on the door's original position. However, as wireless electric garage doors increased in popularity after World War II and in the ensuing years, mechanisms were required to ensure that a user opened only his or her garage door, and not his neighbor's, or to ensure that thieves could not easily open a person's garage door. Thus, various code technologies were developed both to ensure that a user uniquely opened his or her garage door, but also to restrict thieves from opening the doors with their own transmitters. Typical modern garage door openers rely mainly on the transmission of unique codes, and further utilize frequency hopping or rolling to wirelessly transmit on different frequencies to prevent thieves from capturing transmitted codes.

A typical house having a wireless garage door opener may have at least one garage door transmitter, and oftentimes may have more than one. Typically, the transmitter is simply a box containing electronics with a simple push-button on the outside thereof. A user simply pushes the button when in range to open and/or close the garage door. The electronics are typically powered by batteries.

In many cases, however, garage door openers may be lost or misplaced, damaged or may otherwise be unusable to open and/or close a garage door, oftentimes leaving a user without an ability to open and/or close the garage door, except using a switch that is often inside the garage itself or otherwise inside a residence. Therefore, to utilize a garage door without a wireless transmitter, the user must gain entry into the residence and manually hit the switch. Oftentimes, however, garage door entry is used to gain entry into a building, and a user may not have other accessible entry points. Without a wireless transmitter, the user would be stranded outside the building with no way to easily gain entry. A need, therefore, exists for a wireless door opening system and method that may be difficult to lose or misplace. Moreover, a need exists for a wireless door opening system and method that may be utilized from a smart phone, table or other like smart device that may be carried on a person.

In addition, although modern garage doors may utilize unique codes and frequency hopping to provide security, thieves may still use security-breaking electronic devices to capture garage door codes and gain access to a garage. Moreover, users may leave their openers in their automobiles that may be parked outside, and a thief can simply gain access to the automobile by breaking the windows (or to which an owner may simply leave unlocked) and obtain the transmitter. Therefore, while modern garage door openers may be useful, they may not be completely foolproof to ward off thieves who may want to go to great lengths to break into a garage or, worse, a residence through the garage.

Moreover, modern garage door opening and closing systems typically have the one or more opener transmitters that are uniquely associated with the electric motor. However, should the opener transmitter become damaged and unusable, or become compromised by a thief, it is often difficult to change the code of the transmitter and the receiver on the motor so that the user may still utilize the motor without replacing the wireless transmitter and receiver. In other words, there is typically no easy way to change the code associated between the transmitter and the receiver.

A need further exists to provide a door opening system and method that provides increased security compared to typical modern garage door opener transmitters. Specifically, a need exists for a door opening system and method that easily thwarts a thief from gaining access to a garage.

Moreover, a need exists for a door opening system and method that provides additional security to ensure that a thief cannot open the garage door. Specifically, a need exists for a door opening system and method that allows a user to change unique codes or other like security measures in case of compromised security.

Oftentimes, homeowners may have multiple garage doors to house vehicles or other items within a garage space. Indeed, many homes have at least two garage doors, and almost 17% of new home construction includes three garage doors. Thus, a homeowner is typically required to carry two or more different opener transmitters to ensure that he or she can open the two or more garage doors. At the very least, a single unit may be used with a plurality of separate buttons that may be utilized to open each individual garage door. However, garage door systems may become unwieldy when they contain several garage doors.

A need, therefore, exists for door opener systems and methods that may easily allow for the opening and/or closing of multiple garage doors. Specifically, a need exists for a door opener system and method that may allow a user to easily track and control the multiple garage doors.

Of course, while the present invention may be specifically described as being related to garage door openers, it should be noted that the present invention may be utilized with any type of wireless opener system, such as gate opener systems, and other like devices. For example, users that may be live in gated communities may need to gain access to the gate to open and/or close the same. A need, therefore, exists for opener systems and methods that may open gates, doors, or other like devices to gain access to an area.

### SUMMARY OF THE INVENTION

The present invention relates to an automatic wireless Bluetooth®-enabled garage door opener, gate opener or other automatic door opening system and method. Specifically, the door opener system and method comprises a Bluetooth wireless receiver interconnected to a low voltage wired garage door opening system, and a control application on a smart device, such as a smart phone, tablet, or other like Bluetooth®-enabled wireless transmitter.

To this end, in an embodiment of the present invention, a smart device comprises an app for controlling, via Bluetooth protocol, an opener for a door by sending a Bluetooth signal to a receiver to trigger the opening or closing of the door.

It is, therefore, an advantage and objective of the present invention to provide a wireless door opening system and method that may be difficult to lose or misplace.

Moreover, it is an advantage and objective of the present invention to provide a wireless door opening system and method that may be utilized from a smart phone, tablet or other like smart device that may be carried on a person.

Further, it is an advantage and objective of the present invention to provide a wireless door opening system and method that provides increased security compared to typical modern garage door opener transmitters.

Specifically, it is an advantage and objective of the present invention to provide a wireless door opening system and method that easily thwarts a thief from gaining access to a garage or particular area.

Moreover, it is an advantage and objective of the present invention to provide wireless a door opening system and method that provides additional security to ensure that a thief cannot open a garage door or gate.

Specifically, it is an advantage and objective of the present invention to provide a wireless door opening system and method that allows a user to change unique codes or other like security measures in case of compromised security.

In addition, it is an advantage and objective of the present invention to provide a wireless door opener system and method that may easily allow for the opening and/or closing of multiple garage doors or gates.

Specifically, it is an advantage and objective to provide a wireless door opener system and method that may allow a user to easily track and control the multiple garage doors or gates.

Further, it is an advantage and objective of the present invention to provide a wireless opener system and method that may open gates, doors, or other like devices to gain access to an area.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a prior art view of a garage.

FIG. 2 illustrates use of a smart device to wirelessly send a signal to open a garage door via Bluetooth wireless protocol in an embodiment of the present invention.

### DETAILED DESCRIPTION OF THE PRESENTLY PREFERRED EMBODIMENTS

The present invention relates to an automatic wireless Bluetooth®-enabled garage door opener, gate opener or other automatic door opening system and method. Specifically, the door opener system and method comprises a Bluetooth wireless receiver interconnected to a low voltage wired garage door opening system, and a control application on a smart device, such as a smart phone, tablet, or other like Bluetooth®-enabled wireless transmitter.

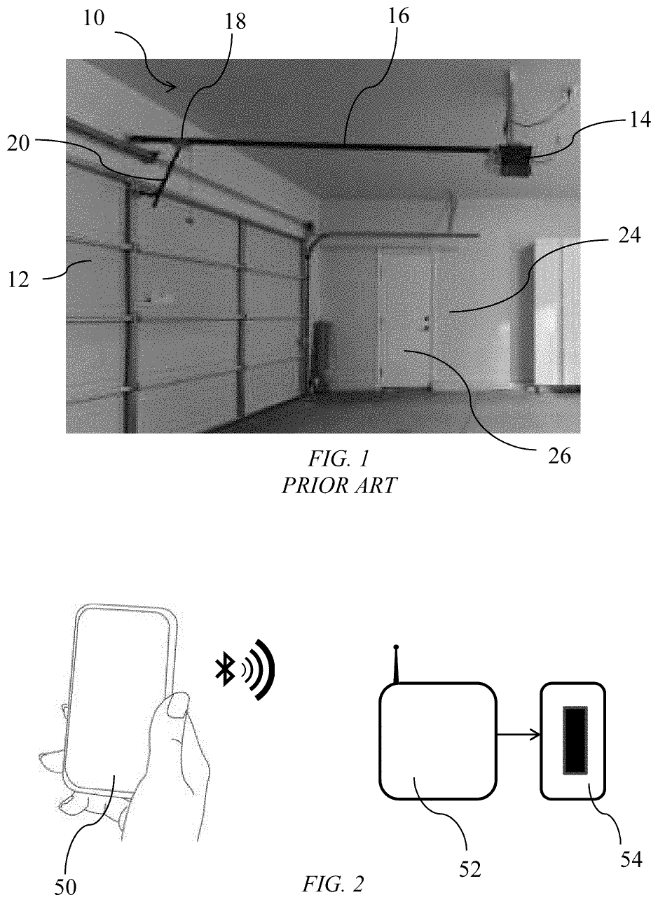

FIG. 1 illustrates a prior art garage 10 having a standard garage door 12 that is raised and lowered via an electric motor 14 suspended above the garage 10 and at a terminal end of a track 16. The electric motor 14 moves a carriage 18 via a chain, cable or other like means, along the track, the carriage 18 connected to an arm 20 attached to the garage door 12. As the carriage 18 moves along the track 16 toward the electric motor 14, the garage door 12 is raised. Likewise, as the carriage moves along the track 16 away from the electric motor, the garage door 12 is lowered. Edges of the garage door 12 may follow side tracks, such as side track 22 to ensure alignment of the garage door 12 as it is raised and lowered.

Typically, the electric garage door 12 has a pushbutton 24 that may be hardwired to the electric motor 14 or wirelessly connected to the electric motor 14. Typically, the pushbutton 24 is mounted to the wall of the garage 10 so that a user has easy access thereto when he or she enters the garage 10 through garage door 26. When the pushbutton 24 is pressed, a signal is sent to the electric motor 14 to raise or lower the garage door 12, depending on its initial position.

In addition, users typically have a handheld wireless transmitter (not shown) that the user may carry that may wirelessly send a signal to the electric motor 14 to raise or lower the garage door 12 depending on its position. As noted above, these handheld wireless transmitters may be easily lost, misplaced, damaged and/or stolen.

Of course, while the present invention may be described as relating to a garage door opener, it should be noted that the present invention may be used with any device meant to open a door, such as a gate, a barn door, a hangar door, or any other like door or gate using an electric motor, as apparent to one of ordinary skill in the art, and the present invention should not be limited as described herein.

Referring now to FIG. 2, in an embodiment of the present invention, a handheld smart device 50 may be used to wirelessly send a signal to a receiver 52 that may be electronically connected, via wired or wireless connection, to a pushbutton 54 that may be used to control the opening and/or closing of a garage door. Preferably, the smart device 50 may be a smart phone, tablet computer, or any other device capable of generating and sending a Bluetooth wireless signal to be received by the receiver 52. Although the Bluetooth wireless standard is described herein for communication between the smart device 50 and the receiver 52, it should be noted that any wireless transmission protocol may be used, whether known or developed in the future.

When the receiver 52 receives a signal from the smart device 50, it may electronically signal to the pushbutton 54 to send a signal to an electric motor of a garage door to raise or lower the garage door, depending on its initial position. Alternatively, the receiver 52 may be directly electrically connected to an electric motor, bypassing the pushbutton 54, and directly signaling the electric motor to raise or lower the garage door.

The smart device 50 may have an application (“app”) that may present a virtual pushbutton icon to a user thereof, such that pressing the pushbutton icon sends the signal to the receiver 52. Of course, any user interface may be utilized on the smart device 50 for allowing a user to send a signal to the garage door opener to open or close the same. For ease of use, the pushbutton icon may be relatively large, such that a user may have little difficulty pushing the same on the smart device 50 screen. Preferably, the pushbutton icon may be presented to a user on a touch-sensitive screen to mimic the actual pushing of a pushbutton.

The app on the smart device 50 may present a user with a simple interface for pairing the smart device 50 with the receiver 52 using the Bluetooth wireless protocol. To aid in the security of the app and the receiver, the user may be presented with a security code that he or she may be required to enter to access the app and to control the function of a garage door via the app. Thus, even if the smart device 50 falls into the wrong hands, a would-be thief would be required to know the security code to access the app. Simply having the smart device 50 would be of no benefit without also knowing the security code. Of course, any other security means may be utilized to ensure that the app is not used by the wrong people, including PINs, biometric security features, such as fingerprint scanners, retina scanners, or other like security means.

Indeed, security may be increased by forcing a user to adopt a security code or other security means upon setting up the app for use with the paired receiver. For example, upon setting up the app and pairing with the receiver, the app may force a user to change a default PIN to one of the user's choice. Moreover, the PIN may be changeable at any time to increase security, whether prompted by the user or automatically required by the app. In addition, the app may block users from using easily-hacked PIN choices, such as 1234 or 0000 or another like easily discernible PIN choice.

The receiver 52, as illustrated in FIG. 2, may be paired with a single Bluetooth enabled smart device 50 or may be paired with a plurality of smart devices, each having its own security to ensure that the garage door cannot be hacked. Specifically, it is common for individual users or many users to have a plurality of smart devices, where the individual user may wish to have the ability to open the garage door from any one of the smart devices, or where a plurality of individuals may wish to have access to a garage door. Preferably, the receiver 52 may pair with more than one smart device at the same time.

The receiver 52 may utilize a Bluetooth chip having a substantial range, allowing for connection to a smart device at ranges up to 25 meters or more. The app on the smart device 50 may have a signal meter alerting a user as to how strong a signal may be between the smart device 50 and the receiver 52, which may be used as a range finder so that the user is assured of being within range to send a signal from the smart device 50 to the receiver 52.

As noted, in a preferred embodiment, the receiver 52 may be electrically connected to a pushbutton, such as, preferably, a hardwired pushbutton via the pushbutton bellwire or wireless pushbutton that is physically within the garage, such as on the wall thereof. The receiver 52 may have a relatively small footprint, and may easily be mounted proximate the pushbutton so that the two may be easily electrically connected. The receiver 52 may have LEDs or other visual indicator alerting a user of status of the receiver 52. Moreover, the receiver 52 may have a reset switch so that the receiver may be reset to default or factory settings.

In an embodiment, the receiver 52 may be configured to replace the pushbutton 54. Specifically, the receiver 52 may have a pushbutton thereon, whether a real pushbutton or a virtual pushbutton, so that a user may have access to controlling the garage door directly from the receiver 52.

In an alternate embodiment of the present invention, a receiver (not shown) may be electrically connected to more than one garage door, and an app on one or more paired smart devices may provide separate controls for each of the garage doors. Thus, the app may provide a user with a single control for accessing and controlling the three garage doors.

In a further alternate embodiment of the present invention, one or more garage doors, gates or other like accessing means, may be controlled by a plurality of users. Specifically, the app may allow a plurality of users access to one or more of the plurality of garage doors. The apps on a plurality of smart devices may be centrally controlled through a networked control, allowing an administrator to deny or allow users access via the apps on their smart devices. For example, an apartment complex may have a garage door that may be accessible by residents thereof. Each resident may have the app for controlling the garage door on their smart devices, and access to allow the users to have individual control of the garage door may be controlled by an administrator on a networked control module.

Thus, when a resident leaves the apartment complex, the administrator may simply deny the ex-resident access to the garage door by blocking the user from using the app to open or close the garage door. Likewise, when a new resident moves in, the administrator may allow access by the new resident of the access to the garage door. Alternately, a plurality of users may require access to a plurality of garage doors or gates, and the central control module may allow the administrator to allow or deny access by any one of the plurality of users to any one or more of the doors or gates, as desired by the administrator.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

We claim:

1. A system for controlling a door comprising:
a door having an open position and a closed position, wherein the door further comprises a motor mechanically connected to the door to move the door between the open position and the closed position, the motor comprising a pushbutton switch electrically connected to the motor, wherein the pushbutton switch activates the motor when pressed;
a wireless receiver electrically connected to the pushbutton switch, wherein the wireless receiver comprises a changeable PIN, wherein the wireless receiver is configured to receive a Bluetooth signal from a mobile smart device, wherein the mobile smart device is selected from the group consisting of a smart phone and a tablet computer, wherein the Bluetooth signal has an embedded security code therein and further wherein when the wireless receiver receives the Bluetooth signal from the mobile smart device and further wherein when the embedded security code of the Bluetooth signal matches the changeable PIN of the wireless receiver, activates the motor by sending an electric signal through the pushbutton switch to the motor and when the embedded security code of the Bluetooth signal from the mobile smart device does not match the changeable PIN of the wireless receiver, the first motor is not activated, and further wherein the wireless receiver is not connected to any computer networks; and
an application resident on the mobile smart device comprising an icon visible on a screen of the mobile smart device representing a pushbutton switch, wherein activating the icon on the screen of the mobile smart device sends the Bluetooth signal from the mobile smart device to the receiver.

2. The system of claim 1 wherein the door is a garage door.

3. The system of claim 1 wherein the application comprises a security code, wherein entering the security code into the application activates the application for use by a user.

4. The system of claim 1 wherein the pushbutton switch is disposed on a wall near the door.

5. The system of claim 1 wherein the door is a garage door for a garage and the pushbutton switch is mounted on a wall of the garage.

6. The system of claim 1 comprising a second application resident on a second mobile smart device comprising an icon visible on a screen of the second mobile smart device representing a pushbutton switch, wherein activating the icon on the screen of the second mobile smart device sends a second Bluetooth signal from the second mobile smart device to the receiver.

7. A system for controlling one or more doors comprising:
a first door having an open position and a closed position, wherein the first door further comprises a first motor mechanically connected to the first door to move the first door between the open position and the closed position;
a controller comprising a wireless receiver electrically connected to the motor, wherein the wireless receiver comprises a changeable PIN, wherein the wireless receiver is configured to receive first and second Bluetooth signals from first and second mobile smart devices, wherein each of the first and second mobile smart devices is selected from the group consisting of a smart phone and a tablet computer, each of the first and second Bluetooth signals comprising an embedded security code, and further wherein when the wireless receiver receives the first or second Bluetooth signal from the first or second mobile smart device and further wherein when the embedded security code of the first or second Bluetooth signal matches the changeable PIN of the wireless receiver, activates the first motor by sending an electric signal to the first motor and when the embedded security code of the first or second Bluetooth signal does not match the changeable PIN of the wireless receiver, the first motor is not activated, and further wherein the wireless receiver is not connected to any computer networks;
a first application resident on the first mobile smart device comprising an icon visible on a screen of the first mobile smart device representing a pushbutton switch, wherein activating the icon on the screen of the first mobile smart device sends the first Bluetooth signal from the first mobile smart device to the wireless receiver; and
a second application resident on the second mobile smart device comprising an icon visible on the screen of the second mobile smart device representing a pushbutton switch, wherein activating the icon on the screen of the second mobile smart device sends the second Bluetooth signal from the second mobile smart device to the wireless receiver.

8. The system of claim 7 wherein the door is a garage door.

9. The system of claim 7 wherein the first application comprises a first security code, wherein entering the first security code into the first application activates the first application.

10. The system of claim 9 wherein the second application comprises a second security code, wherein entering the second security code into the second application activates the second application.

11. The system of claim 7 further comprising:
a second door having an open position and a closed position, wherein the second door further comprises a second motor mechanically connected to the second door to move the second door between the open position and the closed position, wherein the second motor is electrically connected to the controller, wherein the wireless receiver is configured to receive a third Bluetooth signal from a third mobile smart device and further wherein when the wireless receiver receives the third Bluetooth signal from the third mobile smart device, activates the second motor by sending an electric signal to the second motor; and
a third application resident on the third smart device comprising an icon visible on a screen of the third mobile smart device representing a pushbutton switch, wherein activating the icon on the screen of the third mobile smart device sends the first Bluetooth signal from the third mobile smart device to the wireless receiver.

12. The system of claim 11 wherein the first application comprises a first security code, wherein entering the first security code into the first application activates the first application for use by a first user, wherein the second application comprises a second security code, wherein entering the second security code into the second application activates the second application for use by a second user, and further wherein the third application comprises a third security code, wherein entering the third security code into the third application activates the third application for use by a third user.

13. A system for controlling a door comprising:
a first door having an open position and a closed position, wherein the first door further comprises a first motor mechanically connected to the first door to move the first door between the open position and the closed position;
a second door having an open position and a closed position, wherein the second door further comprises a second motor mechanically connected to the second door to move the second door between the open position and the closed position;
a controller comprising a wireless receiver electrically connected to the first motor and the second motor and comprising a changeable PIN, wherein the wireless receiver is configured to receive first and second Bluetooth signals from first and second mobile smart devices, each of the first and second mobile smart devices selected from the group consisting of a smart phone and a tablet computer, each of the first and second Bluetooth signals comprising an embedded security code, and further wherein when the wireless receiver receives the first Bluetooth signal from the first mobile smart device and further wherein when the embedded security code of the first Bluetooth signal matches the changeable PIN of the wireless receiver, the controller activates the first motor by sending an electric signal to the first motor and when the embedded security code of the first Bluetooth signal does not match the changeable PIN of the wireless receiver, the first motor is not activated, and further wherein when the wireless receiver receives the second Bluetooth signal from the second mobile smart device and further wherein when the embedded security code of the second Bluetooth signal matches the changeable PIN of the wireless receiver, the controller activates the second motor by sending an electric signal to the second motor and when the embedded security code of the second Bluetooth signal does not match the changeable PIN of the wireless receiver, the second motor is not activated, and further wherein the wireless receiver is not connected to any computer networks;
a first application resident on the first mobile smart device comprising an icon visible on a screen of the first smart device representing a pushbutton switch, wherein activating the icon on the screen of the first mobile smart device sends the first Bluetooth signal from the first mobile smart device to the wireless receiver for opening the first door; and
a second application resident on the second mobile smart device comprising an icon visible on the screen of the second mobile smart device representing a pushbutton switch, wherein activating the icon on the screen of the second mobile smart device sends the second Bluetooth signal from the second mobile smart device to the wireless receiver for opening the second door.

14. The system of claim 13 wherein the first door is a garage door.

15. The system of claim 14 wherein the second door is a garage door.

16. The system of claim 13 wherein the first application comprises a first security code, wherein entering the first security code into the first application activates the first application for use by a first user, wherein the second application comprises a second security code, wherein entering the second security code into the second application activates the second application for use by a second user.
